(19) United States
(12) Patent Application Publication
(10) Pub. No.: US 2013/0247859 A1
(43) Pub. Date: Sep. 26, 2013

(54) AIR INTAKE DEVICE FOR AN INTERNAL COMBUSTION ENGINE OF A VEHICLE

(71) Applicant: GM GLOBAL TECHNOLOGY OPERATIONS LLC, Detroit, MI (US)

(72) Inventors: Michael CREMER, Bad Muenster-Ebernburg (DE); Baris CAMURTAY, Muenchen (DE); Gerwin TITTES, Trebur (DE)

(73) Assignee: GM GLOBAL TECHNOLOGY OPERATIONS LLC, Detroit, MI (US)

(21) Appl. No.: 13/780,782

(22) Filed: Feb. 28, 2013

(30) Foreign Application Priority Data
Mar. 14, 2012 (DE) 10 2012 005 103.4

(51) Int. Cl. F02M 35/10

(52) U.S. Cl. CPC F02M 35/10091
USPC 123/184.21

(57) ABSTRACT

An air intake device for an internal combustion engine of a vehicle is provided. The air intake device includes a cylinder head of a cylinder, an inlet port, which is connected to the cylinder head, and a guiding system. The guiding system includes a separating wall element that divides at least one portion of the inlet port with respect to the cylinder head into a first upper part port and second lower part port. The guiding system has a flap element for opening and closing the first upper part port.

### CROSS-REFERENCE TO RELATED APPLICATION

This application claims priority to German Patent Application No. 10 2012 005 103.4, filed Mar. 14, 2012, which is incorporated herein by reference in its entirety.

### TECHNICAL FIELD

The technical field relates to an air intake device for an internal combustion engine and in particular an air intake device having a guiding system for generating mixture formation in a cylinder of an internal combustion engine of a vehicle.

### BACKGROUND

From DE 299 24 529 U1 an air intake system having an intake port or intake port lower part is known, which is flanged to a cylinder head via a cylinder head flange. The cylinder head limits a combustion space of a cylinder. The intake port lower part forms an air port, which is connected to the inlet port in the cylinder head in a fluidically guiding manner. In the inlet port of the cylinder head a separating wall is arranged, which separates the inlet port over a predetermined distance between the cylinder head flange and the inlet opening into two ports. In the intake port lower part a switching flap is furthermore rotatably arranged, so that the switching flap can be optionally pivoted into an open state, in which a cross section of the air port and of the inlet port is completely open, and into a closed state, in which said switching flap strikes the separating wall with its free end, thereby closing off the lower part port

Before this background, it is at least one object herein to provide an improved air intake device for a vehicle. In particular, it is at least one object to provide on the one hand an air intake device with a high flow rate and on the other hand generate a high degree of turbulence in the cylinder of an internal combustion engine for mixture formation if required. In addition, other objects, desirable features and characteristics will become apparent from the subsequent summary and detailed description, and the appended claims, taken in conjunction with the accompanying drawings and this background.

### SUMMARY

In an exemplary embodiment, an air intake device for an internal combustion engine of a vehicle is provided. The air intake device includes at least one cylinder head of a cylinder, at least one inlet port, which is connected to the cylinder head, and a guiding system, wherein the guiding system comprises a separating wall element. The separating wall element divides at least one portion of the inlet port with respect to the cylinder head into a first upper part port and a second lower part port and the guiding system comprises a flap element for opening and closing the first upper part port.

In an embodiment, at least one inlet valve can be arranged in the cylinder head, wherein a flow through the second lower part port of the inlet port is guided to a rear or inner region of a valve disc of the inlet valve. In the process, a tumble or turbulence is generated in the cylinder interior, which improves the mixture formation. This tumble is substantially created through the communication of the lower part port with the valve disc and the arrangement and shaping of inlet port, port separation and inlet valve in such a manner that the inflowing air tears off at the end of the port separation and via this edge flows in the direction of the rear valve disc.

In a further embodiment, the inlet port is formed as a filling port, which, for example, has low flow-mechanical resistance. Because of this, a large flow rate can be achieved with opened first upper and second lower part port, which in particular is larger than with conventional tumble ports, and is advantageous in particular at high engine rotational speeds.

In another embodiment, the flap element is formed so that it can pivot about an axis of rotation and can be pivoted into positions in which the first upper part port is partially opened, completely opened and completely closed. Through the opening and closing of the first upper part port, the cross section of this part port and thus of the inlet port as a whole can be specifically varied, depending on for example the state of loading.

In a further embodiment, the second lower part port is opened while the first upper part port is opened or closed by means of the flap element. In this way, a tumble can be generated in the cylinder interior at low engine rotational speeds and a faster combustion achieved. Here, the air is directed through the second lower part port to a rear or inner region of the valve disc of the inlet valve.

In an embodiment, the separating wall element is twisted in such a manner that the separating wall element constitutes a horizontal or substantially horizontal edge towards the inlet and thus can be closed off by a suitably arranged flap and the air induction in the cylinder is subjected to a swirl in addition to the tumble direction. In the case of a plurality of inlet ports per cylinder, the twisted separating wall element can be arranged equidirectionally or counterdirectionally in the respective assigned inlet port. Likewise, the twisted or plane separating wall element can be arranged at an angle α with respect to the longitudinal axis of the inlet port. In another embodiment, the twisted or plane separating wall element can be additionally or alternatively arranged in the transverse axis of the inlet port or at an angle β with respect to the transverse axis of the inlet port, in order to divide the inlet port into an upper and lower part port with respect to the cylinder head. In this way, the air flow can be specifically guided through the inlet port into the cylinder through the suitable positioning of the separating wall element.

In a further embodiment, the separating wall element is a plane or flat separating wall element. Responding to this, the separating wall element is arranged plane or flat in the inlet port.

### BRIEF DESCRIPTION OF THE DRAWINGS

The various embodiments will hereinafter be described in conjunction with the following drawing figures, wherein like numerals denote like elements, and wherein:

FIG. 1 is a cross-sectional view of an air intake device with a guiding system, wherein the guiding system comprises a separating wall element and a flap element, which is arranged in a plane with the separating wall element, in accordance with an exemplary embodiment;

FIG. 2 is a cross-sectional view of an air intake device with a guiding system according to a further exemplary embodiment of the air intake device according to FIG. 1, wherein the flap element of the guiding system is arranged offset with respect to the separating wall element in the inlet port;

FIG. 3 is a cross-sectional view of an air intake device with a guiding system according to another exemplary embodiment of the air intake device according to FIG. 1, wherein the flap element of the guiding system is arranged on the circumference of the inlet port;

FIG. 4 is a cross-sectional view of an air intake device with a guiding system, wherein the separating wall element is provided in the inlet port in a twisted or wound manner, in accordance with an exemplary embodiment; and

FIG. 5 is a diagram in which the tumble or the turbulence in the cylinder is shown as a function of a valve stroke of the inlet valve of the cylinder.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

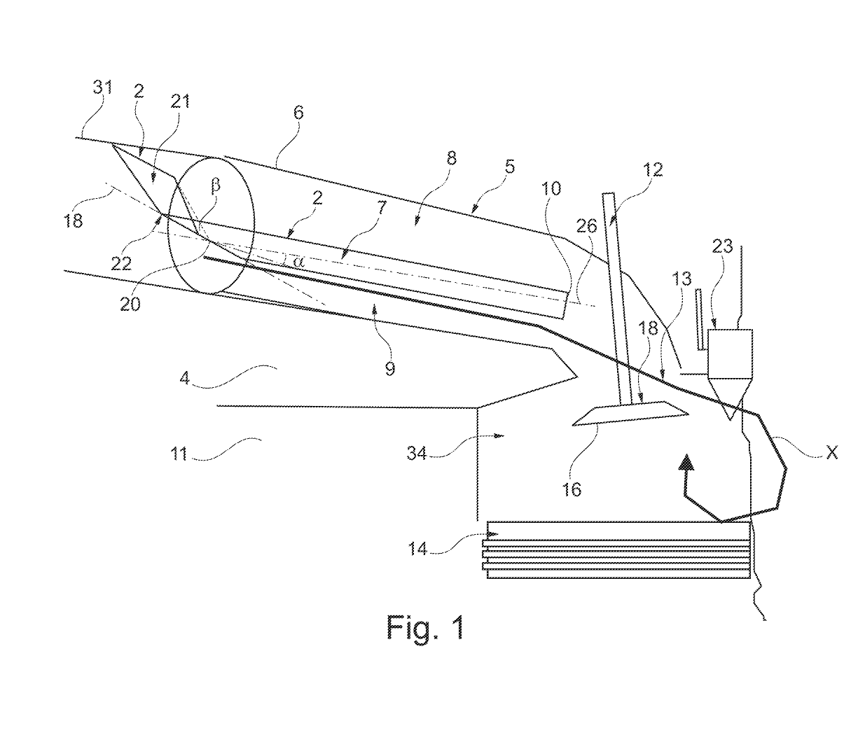

FIG. 1 shows a cross-sectional view of an air intake device 1 with a guiding system 2 for an internal combustion engine according to an embodiment.

The air intake device 1 in this case comprises at least one cylinder 3 with a cylinder head 4 and a cylinder block 11, in which a cylinder piston 14 is arranged. Furthermore, the air intake device 1 comprises at least one inlet port 5 which with its opening 13 opens into the cylinder head 4, and at least one exhaust port. In the cylinder head 4, additionally at least one inlet valve 12 and at least one exhaust valve (not shown) are arranged, as well as an injection valve 23 for injecting fuel into the combustion space 34 of the cylinder 3.

The inlet port 5 is formed as a filling port 6. A filling port 6 is a port which (in contrast with a tumble port or swirl port) has a low or preferably low flow-mechanical resistance. Because of this, the inlet port 5 has a high flow rate, in particular compared with tumble or swirl ports (as these are usual with supercharged spark-ignition or diesel engines). A high flow rate is required in particular at high rotational speeds of the engine.

According to the embodiment shown in FIG. 1, the guiding system 2 comprises a separating wall element 7, which in the inlet port 5 is arranged plane or level in such a manner that it divides the inlet port 5, with respect to the cylinder head 4, into a first upper part port 8 and a second lower part port 9.

The separating wall element 7 in the exemplary embodiment in FIG. 1 is for example arranged in the plane which is defined by the longitudinal axis 26 and the transverse axis 18 of the inlet port 5. Accordingly, the separating wall element 7 forms a horizontal edge 20 with respect to the inlet port 5 (corresponding to the horizontal transverse axis of the inlet port). The—in flow direction—front, horizontal edge 20 of the separating wall element 7 allows a particularly simple assembly and actuation of a flap element described in the following for opening and closing the first upper part port.

Likewise, the separating wall element 7 can also be arranged inclined with respect to the transverse axis 18 of the inlet port 5 at an angle β and/or be arranged inclined to the longitudinal axis 26 of the inlet port 5 at an angle α, depending on function and purpose. Depending on the inclination of the separating wall element 7 with respect to the longitudinal axis 26 of the inlet port, a venturi effect or a jet flow can be achieved.

The separating wall 7 can thus also be arranged in a plane other than that defined by the longitudinal axis 26 and the transverse axis 18 of the inlet port 5. Here, the plane of the separating wall 7 can intersect the plane, which is defined by the longitudinal axis 26 and transverse axis 18 of the inlet port 5 or be arranged parallel to the plane, in order to divide the inlet port 5 with respect to the cylinder head 4 into a first upper and second lower part port.

An—in flow direction—rear edge or flow separation edge 10 of the separating wall element 7 can be configured so that it does not end horizontally but is equipped with a contour which generates an uneven flow separation and thus a turbulence that is adapted to the combustion space geometry. The flow separation edge 10 can furthermore be formed as an edge which is rounded off, tapers into a point or sloping, in particular as an edge formed sloping downwards or tapering into a point.

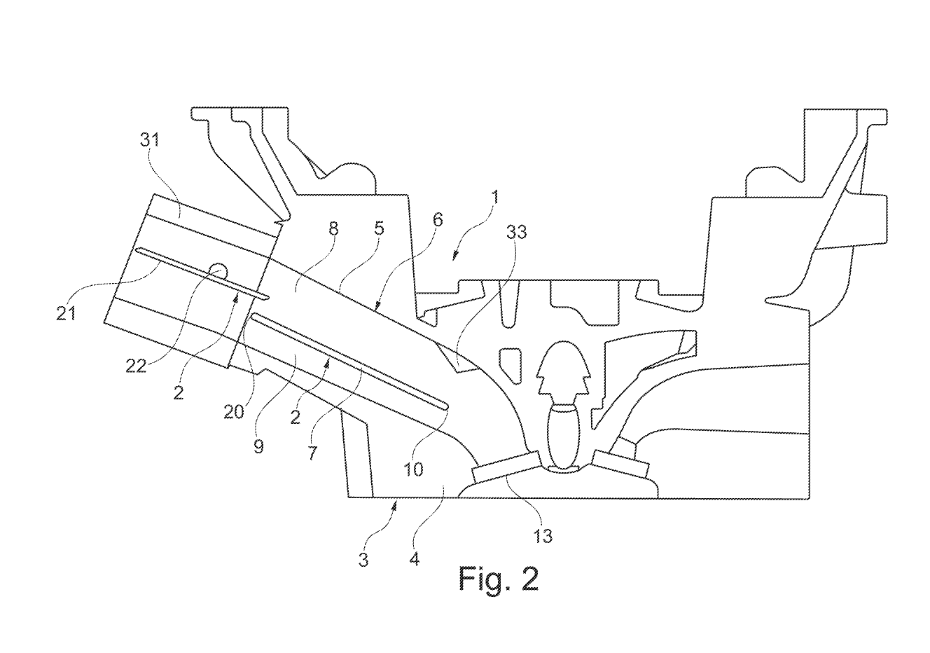

The previously made explanations made regarding the arrangement of the separating wall element 7 and for forming the flow separation edge 10 apply also to all other embodiments and in particular to the exemplary embodiments shown in the following FIG. 2 to 4.

Furthermore, the guiding system 2 comprises a flap element 21 with an axis of rotation 22, which is pivotably arranged about its axis of rotation 22 in the inlet port 5 or an intake port (not shown) that is connected to the inlet port, that it can partially or completely open and close the first upper part port 8, while the second lower part port 9 remains opened.

To this end, the flap element 21 is arranged in the exemplary embodiment shown in FIG. 1 with its axis of rotation 22 in a common plane with the separating wall element 7. The flap element 21 in this case can be pivoted between a position, in which the first upper part port 8 is completely or substantially completely closed, and a position, in which the first upper part port 8 is at least partially opened or completely opened. The second lower part port 9 remains, while the first upper part port 8 is opened or closed by means of the flap element 21, preferentially completely or substantially completely opened.

In the exemplary embodiment shown in FIG. 1, the flap element 21 is pivoted into a position, in which it for example almost completely closes the first upper part port 8. Because of this, the air flowing into the inlet port 5, as is indicated in FIG. 1 with the arrow X, is guided through the second lower part port 9 and directed onto a rear or inner region 19 of a valve disc 16 of the inlet valve 12. The cylinder internal flow that is created in the process has a high tumble or a high degree of turbulence.

The high tumble in the combustion space of the cylinder 3 causes a better mixing-through of an air-fuel mixture and thus leads to a faster combustion. Because of this, the fuel consumption can be reduced and improved emission values achieved.

In that the flap element 21 opens and closes the first upper part port 8, the inlet port 5 in the form of a filling port 6 can be subjected to a charge movement characteristic without forfeiting its high flow rate. As previously described, this is achieved in that the combustion air is guided in such a manner that it flows through the second lower part port 9 onto the rear or inner region 19 of the valve disc 16 of the valve 12. In the process, the—in flow direction of the inlet port 5—inner end of the separating wall 7 can serve as flow separation edge 10.

The tumble or the turbulence in the cylinder 3 can be controlled and varied as desired and accordingly, different load ranges of an internal combustion engine can be individually controlled, depending on the position into which the flap element 21 is pivoted in order to partially or completely open and close the first upper part port 8.

The separating wall element 7 is fixed in the inlet port 5 and for example integrally formed with the inlet port 5 or fastened in the inlet port 5 as a separate part for example in the form of a baffle plate or a metal plate, as is indicated in FIG. 1. To this end, the guiding element 7 can be provided as a baffle plate or metal plate that can be slid into a respective guide, e.g. a groove or a slot in the inlet port 5. Here, the guide is provided on opposite sides of the wall of the inlet port for receiving and guiding the separating wall element 7 on both sides.

FIG. 2 furthermore shows a sectional view of an air intake device 1 with a guiding system 2, according to a further exemplary embodiment of the air intake device according to FIG. 1. The exemplary embodiment in FIG. 2 substantially corresponds to that shown in FIG. 1, so that in this respect reference is made to this description regarding FIG. 1, in order to avoid unnecessary repetitions. The exemplary embodiment shown in FIG. 2 differs from the one shown according to FIG. 1 in that the flap element 21 with its axis of rotation 22 is arranged in the inlet port 5 or the intake port 31 connected to the inlet port 5 offset with respect to the separating wall element 7 for opening and closing the first upper part port 8. Like the inlet port 5 in FIG. 1, the inlet port 5 in FIG. 2 is formed as a filling port 6. In the exemplary embodiment shown in FIG. 2, a part of a valve stem guide 33 stands into the inlet port 5. This valve stem guide 33 however has no influence on the inlet port 5 as such being formed as a filling port 6 and, accordingly, be arranged and formed in such a manner that it does not stand into the inlet port 5.

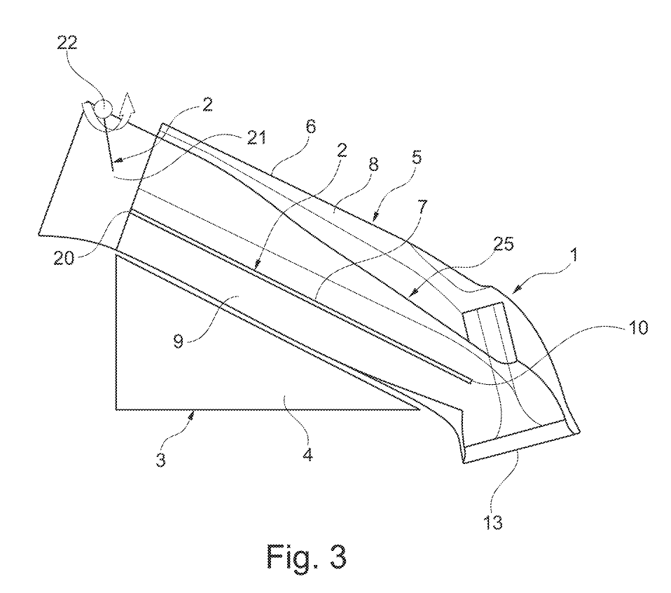

In addition, a view of an air intake device 1 with a guiding system 2 according to another exemplary embodiment of the air intake device according to FIG. 1 is shown in FIG. 3. In this exemplary embodiment, the flap element 21 is arranged with its axis of rotation 22 on the wall or on the circumference of the inlet port 5 or an intake port (not shown) connected to the inlet port 5 for opening and closing the first upper part port 8, while the second lower part port 9 remains opened.

In the view in FIG. 3, a tumble port 25 in the form of a filling port 6 is drawn in over the inlet port 5 for comparison. Such a tumble port 25 has a larger flow-mechanical resistance in order to generate a high tumble or a high turbulence. However, this results in a lower flow rate compared with a filling port 6.

According to the embodiment as shown in FIG. 3, the inlet port 5 is formed as a filling port 6 and has a low or preferably low flow-mechanical resistance and accordingly a high flow rate. Such a high flow rate is needed in particular at high rotational speeds of the engine so that in this case the flap element 21 is pivoted into a position in which the first upper part port 8 is completely or substantially completely opened. At low rotational speeds, the flap element 21, by contrast, can be pivoted into a position as is illustrated in the exemplary embodiment in FIG. 3, in which the first upper part port 8 is closed and the sucked-in air flows through the second lower part port 9 and is directed onto an inner or rear region of the valve disc of the inlet valve (not shown) for generating a cylinder inner flow with a high tumble. This has the advantage that a greater mixing-through of the mixture in the cylinder 3 and a faster combustion can be achieved.

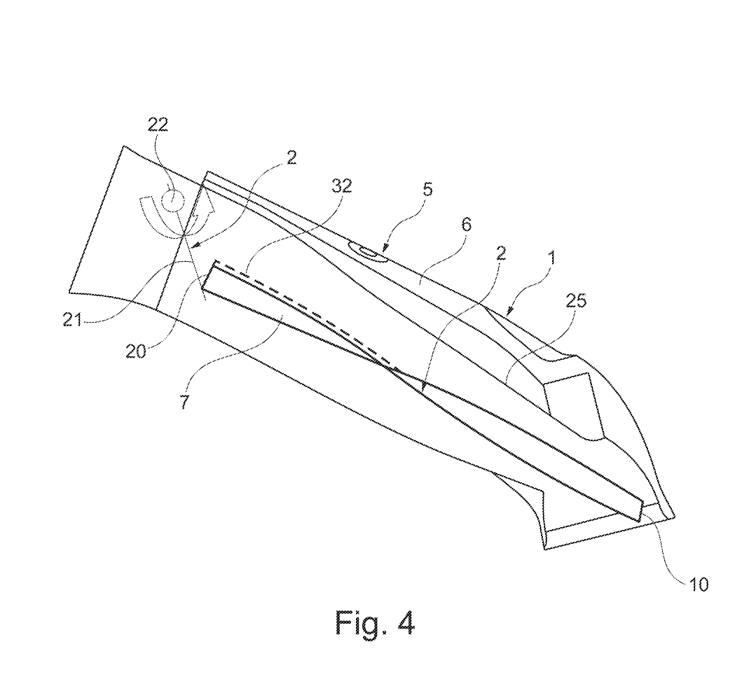

FIG. 4 shows a schematic view of an air intake device 1 with a guiding system 2 according to a further embodiment. This embodiment substantially corresponds to the exemplary embodiment shown in FIG. 3 and differs from the latter by a separating wall element 7, which is arranged twisted or wound in the inlet port 5 in order to divide the inlet port 5 into the first upper and second lower part port 8, 9. It is thus possible to twist the port separation within itself.

Twisting the port separation offers the possibility on the one hand to activate the port with the flap element 21 as a simple control flap, and on the other hand impart a swirl to the combustion air in addition to the tumble movement. The swirl can for example in the case of two inner valves per combustion space, be directed equidirectionally or counterdirectionally.

The separating wall element 7 in this case can be fastened in the inlet port 5 as a separate part. For example, the separating wall element 7 can be inserted into suitable guides 32, such as a for example slots or grooves which are provided on opposite sides of the wall of the inlet port 5 and through the guides 32 be forced into the wound or twisted form and held therein. A guide 32 on the inner wall of the inlet port 5 in this case is indicated with an interrupted line in FIG. 4.

In the exemplary embodiments previously shown in FIGS. 1, 2 and 3, the separating wall element 7 by contrast is arranged in the inlet port 5 as a flat or plane separating wall element 7, wherein to this end guides in the form of for example slots or grooves can likewise be provided on opposite sides on the wall of the inlet port 5 for guiding and holding the separating wall element 7.

In the exemplary embodiment shown in FIG. 4, the flap element 21 is arranged on the circumference of the inlet port with its axis of rotation 22, as previously in the exemplary embodiment in FIG. 3, for opening and closing the first upper part port 8. The flap element 21 with its axis of rotation 22 however can likewise be arranged as in the exemplary embodiment in FIG. 1, in longitudinal direction of the separating wall element 7 or, as shown in the exemplary embodiment in FIG. 2, be arranged in the inlet port 5 or an intake port connected therewith offset with respect to the separating wall element 7.

In the view in FIG. 4, for better understanding, a tumble port 25 is likewise additionally drawn in for comparison over the inlet port 5 which is formed as a filling port 6. As previously described, the inlet port 5 as a filling port 6, as it is employed in the exemplary embodiments in FIG. 1 to 4, has a low or preferably low flow-mechanical resistance and a high flow rate connected with this. A tumble port 25, as it is additionally exemplarily drawn into FIGS. 3 and 4 for comparison, by contrast, has a greater flow-mechanical resistance and accordingly a lower flow rate.

As is shown in the exemplary embodiment in FIG. 4, the flap element 21, for example at a low rotational speed, can be pivoted into a position in which the first upper part port 8 is closed. In this case, the sucked-in air is guided through the second lower part port 9 and directed onto an inner or rear region of the valve disc of the inlet valve (not shown). This generates a cylinder inner flow with a high tumble, as a result of which a better mixing-through of the mixture in the cylinder and a faster combustion can be achieved. At high rotational speeds, the flap element 21 can in turn be pivoted into a position in which the first upper part port 8 is at least partially or completely opened. With completely opened first upper part port 8 and accordingly completely opened second lower part port 9, a high flow rate can be provided through the inlet port 5 in the form of a filling port 6 and in particular a flow rate that is higher than with a tumble port 25.

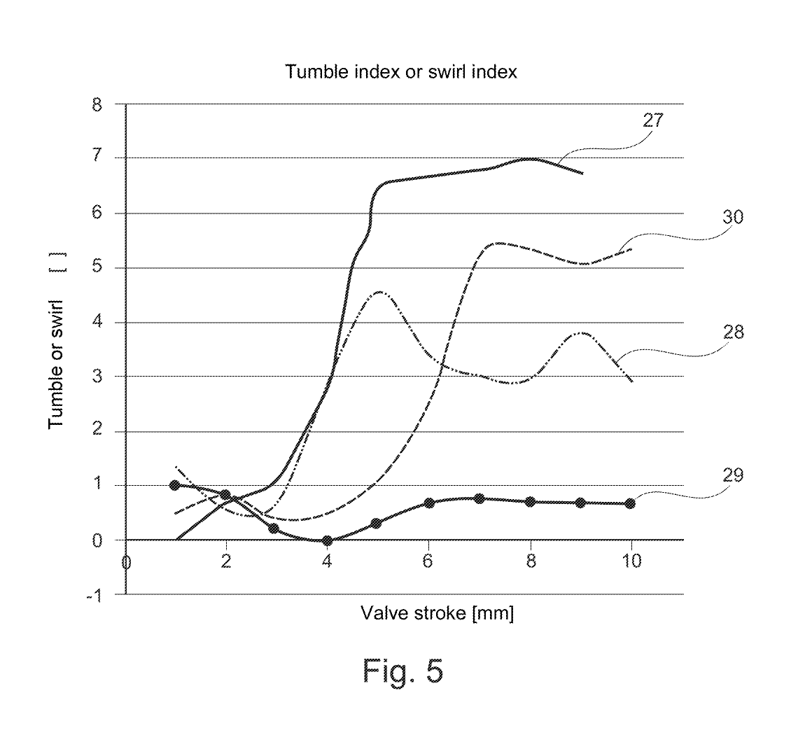

FIG. 5 shows a diagram which shows the curve of the degree of tumble or degree or turbulence generated by a respective air intake device.

The other air intake device in turn is an air intake device for example according to the embodiment shown in FIG. 1, in which the inlet port is formed as a filling port and through the separating wall element is divided into the first upper part port and the second lower part port, wherein the first upper part port can be opened and closed by means of the flap element, while the second lower part port remains always opened. This air intake device generates the curves 27 and 28.

As is evident from the diagram, a rapid high tumble or a rapidly occurring high turbulence in the cylinder interior can be generated in the air intake device according to the embodiment in that the flap element is pivoted into a position in which the first upper part port is completely closed, as the curve 27 shows.

This is advantageous for example at low rotational speeds of the engine. Here, as described before, the sucked-in air is directed through the second lower part port and guided to the rear or inner region of the valve disc of the inlet valve. Because of this, a cylinder inner flow with high tumble and a faster combustion connected with this can be achieved, as well as better emission values.

When the flap element of the exemplary embodiment is pivoted into a position in which the first upper part port is partially closed, a faster but lower tumble or a rapidly-occurring but lower turbulence in the cylinder is created, as the curve 28 shows. In this case, the sucked-in air flows through the partially opened first upper part port and through the open or completely opened second lower part port.

When the flap element of the exemplary embodiment is pivoted into a completely opened position, in which in addition to the second lower part port the first upper part port is also completely opened, a high flow rate and a low tumble are achieved, as the curve 29 shows. The flow rate of the inlet port (curve 29) formed as a filling port is higher than the flow rate of the inlet port formed as tumble port of the conventional air intake device (curve 30). The curve 30 of the conventional air intake device shows that the air intake device with its inlet port in the form of a tumble port generates a tumble that occurs later and is smaller than the tumble that is achieved with closed first second part port of the exemplary embodiment (curve 27).

As shown by the curves 27, 28 and 29 of the exemplary embodiment, the tumble or the turbulence in the cylinder interior and the flow rate of the inlet port can be varied as desired and suitably adapted to different operating states, such as a for example different load states by means of the guiding system, which comprises a separating wall element and a pivotable flap element, for opening and closing the first upper part port.

According to embodiments, an air intake device for an internal combustion engine can be provided which is able by the guiding system to generate an extremely high turbulence in the internal combustion engine and through the particular type of the flow onto the cylinder, i.e. the flow onto the rear or inner region of the valve disc of the inlet valve, generate a very high flow rate as well as a very high degree of turbulence in the internal combustion engine.

The embodiments have a particularly positive effect on the options charging and turbulence in the combustion space and hereby allow a faster combustion of fuel and because of this a reduction of the fuel consumption, as well as improved emission values.

Embodiments of the air intake device with guiding system are able to generate a wide range of charges and a turbulence which promotes a mixture formation, as is also shown previously in the diagram in FIG. 5. Through the interaction for example of flap element, port routing and/or valve arrangement, a flow-mechanically highly variable arrangement of possible port geometries can be provided.

Through the interaction between second lower part port and rear region of the valve disc in embodiments, a higher tumble or turbulence level on the one hand can be achieved through the closing of the upper first part port by means of the flap element and on the other hand a higher flow coefficient can be achieved through additional opening of the first upper part port. In addition, a change of the filling port in favor of a higher turbulence (at the expense of the charge) is not necessary.

Embodiments of the air intake device with guiding system as contemplated herein use a filling port as inlet port. With opened flap element and thus with opened first upper and second lower part ports, this produces a very high charge. With closed flap element and thus closed first upper part port, the flow separation edge of the separating wall element together with the second part lower port generates a jet flow, which is directed onto the rear region of the valve disc and thus generates a high turbulence in the combustion space.

Although the present invention was completely described above by means of preferred exemplary embodiment it is not restricted to this, but can be modified in a wide variety of manners. In particular, the previously described embodiments can also be combined with one another, in particular individual features thereof.

In particular, in the case of a plurality of inlet ports, the separating wall elements can all be arranged plane or flat or twisted in the associated inlet port or different separating wall elements, such as at least one separating wall element that is arranged plane or flat and at least one separating wall element that is arranged twisted or wound can be provided in the respective associated inlet port. Furthermore, all separating wall elements, such as plane or flat and/or twisted or wound in the case of a plurality of inlet ports, can be arranged in the same plane in the respective associated inlet port or in different planes and for example have a different angle α to the longitudinal axis of the inlet port and/or a different angle β to the transverse axis of the inlet port. Furthermore, in the case of a plurality of inlet ports, at least two twisted separating wall elements can be provided in the respective associated inlet port. The separating wall elements in this case can have the same twist or winding or a counterdirectional twist or winding. This applies to all embodiments and in particular to the exemplary embodiments shown in FIG. 1-4.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. An air intake device for an internal combustion engine of a vehicle, the air intake device comprising:
a cylinder head of a cylinder;
an inlet port, which is connected to the cylinder head, and
a guiding system, wherein the guiding system comprises a separating wall element that divides at least one portion of the inlet port with respect to the cylinder head into a first upper part port and a second lower part port and wherein the guiding system comprises a flap element for opening and closing the first upper part port.

2. The air intake device according to claim 1,
wherein an inlet valve is arranged
the cylinder head such that when air flows through the air intake device, it is directed through the second lower part port of the inlet port onto a rear or inner region of a valve disc of the inlet valve.

3. The air intake device according to claim 1,
wherein
the inlet port is formed as a filling port, which has a low flow-mechanical resistance.

4. The air intake device according to claim 1,
wherein
the flap element is capable of pivoting about an axis of rotation and is capable of pivoting into a position in which the first upper part port is partially opened, completely opened, or completely closed.

5. The air intake device according to claim 1,
wherein
the second lower part port, while the first upper part port is opened or closed by the flap element, is opened.

6. The air intake device according to claim 1,
wherein
the flap element is arranged in the inlet port or in an intake port connected to the inlet port.

7. The air intake device according to claim 1,
wherein
the separating wall element is arranged in a longitudinal axis of the inlet port or at an angle to the longitudinal axis of the inlet port.

8. The air intake device according to claim 1,
wherein
the separating wall element is arranged in a transverse axis or horizontal axis of the inlet port or at an angle to the transverse axis of the inlet port.

9. The air intake device according to claim 1,
wherein
the separating wall element is arranged plane or flat in the inlet port.

10. The air intake device according to claim 1,
wherein
the separating wall element is arranged twisted or wound in the inlet port.

11. The air intake device according to claim 1,
wherein
the separating wall element is formed in one piece with the inlet port or is fastened to the inlet port as a separate part, wherein on opposite sides of a wall of the inlet port guides are provided for receiving and guiding the separating wall element.

12. The air intake device according to claim 4,
wherein
the flap element is arranged with the axis of rotation in a common plane with the separating wall element or offset with respect to a plane of the separating wall element in a flow region of the inlet port or is arranged inside on a wall of the inlet port for opening and closing the first upper part port.

13. The air intake device according to claim 1,
wherein
the flap element is adjustable depending on a load state of the internal combustion engine.

14. The air intake device according to claim 1,
wherein
a flow separation edge of the separating wall element ends horizontally or is equipped with a contour that generates an uneven stalling of the flow.

15. A vehicle having an air intake device comprising:
a cylinder head of a cylinder;
an inlet port, which is connected to the cylinder head, and
a guiding system, wherein the guiding system comprises a separating wall element that divides at least one portion of the inlet port with respect to the cylinder head into a first upper part port and a second lower part port and wherein the guiding system comprises a flap element for opening and closing the first upper part port.

16. The air intake device according to claim 14, wherein the flow separation edge is a rounded-edge, an edge tapering into a point, or a sloping edge.

17. The air intake device according to claim 11, wherein the guides are slots or grooves.

18. The vehicle according to claim 15,
wherein an inlet valve is arranged the cylinder head such that when air flows through the air intake device, it is directed through the second lower part port of the inlet port onto a rear or inner region of a valve disc of the inlet valve.

19. The vehicle according to claim 15, wherein the inlet port is formed as a filling port, which has a low flow-mechanical resistance.

20. The vehicle according to claim 15, wherein the flap element is capable of pivoting about an axis of rotation and is capable of pivoting into a position in which the first upper part port is partially opened, completely opened, or completely closed.
